(19) United States
(12) Patent Application Publication
(10) Pub. No.: US 2017/0350315 A1
(43) Pub. Date: Dec. 7, 2017

(54) SUPERCHARGING SYSTEM OF INTERNAL COMBUSTION ENGINE

(71) Applicant: Honda Motor Co.,Ltd., Tokyo (JP)

(72) Inventor: Junichi KAMIO, Saitama (JP)

(73) Assignee: Honda Motor Co.,Ltd., Tokyo (JP)

(21) Appl. No.: 15/615,836

(22) Filed: Jun. 7, 2017

(30) Foreign Application Priority Data
Jun. 7, 2016 (JP) 2016-113221

(51) Int. Cl. F02B 63/04; F02D 41/00; F02B 37/18; F02D 13/02; H02K 7/18; F02M 35/10

(52) U.S. Cl. CPC F02B 63/04; H02K 7/1823; F02M 35/10163; F02B 37/183; F02D 13/0215; F02D 41/0007

(57) ABSTRACT

A supercharging system includes a supercharger including a motor generator, and an intake-side variable cam phase mechanism variably setting a valve-closing timing (IVC angle) of an intake valve. If an operation state of the engine is within a regenerative operation region, a turbine rotation speed controller controls a turbine rotation speed to a target turbine rotation speed set to optimize turbine efficiency by controlling an opening degree of a wastegate valve toward a closing side and by adjusting an amount of power generated by the motor generator. If the operation state is within the regenerative operation region and within a supercharging operation region, a torque controller controls a generated torque to a requested torque by performing cooperative control of an opening degree of an intake bypass valve, the IVC angle and an opening degree of an intake throttle valve.

### CROSS-REFERENCE TO RELATED APPLICATION

This application claims the priority benefit of Japan Application no. 2016-113221, filed on Jun. 7, 2016. The entirety of the above-mentioned patent application is hereby incorporated by reference herein and made a part of this specification.

### BACKGROUND OF THE DISCLOSURE

### Field of the Disclosure

The disclosure relates to a supercharging system of an internal combustion engine. More specifically, the disclosure relates to a supercharging system of an internal combustion engine, wherein the supercharging system includes a supercharger compressing intake air using energy of exhaust gas from the internal combustion engine, and a generator converting a part of a shaft output from a rotary shaft of the supercharger to electrical energy.

### Description of the Related Art

A technique is proposed (e.g., see Japanese Unexamined Patent Application Publication No. 2004-162648) in which in a supercharger in which a compressor provided in an intake passage of an internal combustion engine and a turbine provided in an exhaust passage are connected by a rotary shaft, a part of a shaft output of the rotary shaft obtained by causing exhaust gas from the internal combustion engine to act on the turbine is converted to electrical energy using a generator. In addition, Japanese Unexamined Patent Application Publication No. 2007-262970 shows an invention carrying out regenerative power generation by a generator within a specific rotation speed region in which turbine efficiency is considered high. In the invention shown in Japanese Unexamined Patent Application Publication No. 2007-262970, when regenerative power generation is carried out, to maintain a supercharging pressure at a target supercharging pressure, exhaust energy supplied to the turbine is increased using a variable vane or a wastegate valve, and reduction in acceleration performance is accordingly prevented.

### SUMMARY OF THE DISCLOSURE

### Problems to Be Solved by the Disclosure

In the invention of Japanese Unexamined Patent Application Publication No. 2007-262970, a case is assumed in which by carrying out regenerative power generation during acceleration of an automobile, the supercharging pressure becomes lower than the target supercharging pressure, and the acceleration performance is reduced. However, although it is also conceivable that, when the exhaust gas acts on the turbine in order to carry out regenerative power generation, the intake air may be excessively supercharged by the compressor and surplus torque occurs in response to a driver's request, such case has not been sufficiently discussed in the prior art.

In addition, in the invention of Japanese Unexamined Patent Application Publication No. 2007-262970, examples of a means for controlling the supercharging pressure during regenerative power generation include the variable vane or the wastegate valve. Hence, if surplus torque occurs during regenerative power generation, the supercharging pressure may be reduced using these devices provided in the exhaust system. However, in that case, the exhaust energy supplied to the turbine is reduced, and the electrical energy obtained by the regenerative power generation is also reduced. As a result, there is also a risk that efficiency in the entire system including the supercharger, the generator and the internal combustion engine may be reduced.

The disclosure provides a supercharging system of the internal combustion engine, capable of, while making torque generated by the internal combustion engine correspond to the driver's request, improving efficiency of the entire system made by combining the internal combustion engine, the supercharger and the generator.

### Means for Solving the Problems

(1) A supercharging system (e.g., later-described supercharging system S or Sa) of an internal combustion engine (e.g., later-described engine 1) includes: a supercharger (e.g., later-described supercharger 5), including a compressor (e.g., later-described compressor 51) provided in an intake passage (e.g., later-described main intake pipe 22) of the internal combustion engine, a turbine (e.g., later-described turbine 52) provided in an exhaust passage (e.g., later-described main exhaust pipe 27) of the internal combustion engine, a rotary shaft (e.g., later-described rotary shaft 53) connecting the turbine and the compressor, and a generator (e.g., later-described motor generator 54) converting a part of a shaft output of the rotary shaft to electrical energy; a wastegate valve (e.g., later-described wastegate valve 29), opening and closing an exhaust bypass passage (e.g., later-described exhaust bypass pipe 28) connected to the exhaust passage on an inlet side and an outlet side of the turbine; a turbine rotation speed controller (e.g., later-described power drive unit (PDU) 55 and electronic control unit (ECU) 7, as well as a means relating to execution of later-described turbine rotation speed control), controlling a turbine rotation speed using the wastegate valve and the generator; an intake bypass valve (e.g., later-described intake bypass valve 24), opening and closing an intake bypass passage (e.g., later-described intake bypass pipe 23) connected to the intake passage on an inlet side and an outlet side of the compressor; a variable valve-closing timing device (e.g., later-described intake-side variable cam phase mechanism (IN-side VTC) 15), variably setting a valve-closing timing (e.g., later-described IVC angle) of an intake valve (e.g., later-described intake valve 13) of the internal combustion engine; a torque controller (e.g., later-described ECU 7 and a means relating to execution of later-described torque control), controlling a generated torque of the internal combustion engine using the intake bypass valve and the variable valve-closing timing device; and a regeneration determination unit (e.g., later-described ECU 7 and a means relating to execution of processes in S2 and S3 in FIG. 2), determining whether or not an operation state of the internal combustion engine is within a regenerative operation region in which regenerative operation of the generator is performed. If the operation state is within the regenerative operation region, the turbine rotation speed controller controls the turbine rotation speed within a target range set to optimize turbine efficiency by controlling an opening degree of the wastegate valve toward a closing side and by adjusting an amount of power generated by the generator. If the turbine rotation speed is controlled within the target range and the operation state is within a supercharging operation region in which supercharging operation of the compressor is performed, the torque controller controls the generated torque to a requested torque by performing cooperative control of an opening degree of the intake bypass valve and the valve-closing timing of the intake valve.

(2) In this case, if the turbine rotation speed is controlled within the target range and the operation state is outside the supercharging operation region, the torque controller preferably controls the generated torque to the requested torque by adjusting the valve-closing timing of the intake valve while setting the opening degree of the intake bypass valve to fully opened.

(3) In this case, the supercharging system of the internal combustion engine further includes a shut-off valve (e.g., later-described shut-off valve 30) provided within a section (section from later-described connecting portion a to connecting portion b) in the intake passage that is bypassed by the intake bypass passage, wherein if the turbine rotation speed is controlled within the target range and the operation state is outside the supercharging operation region, the torque controller preferably sets an opening degree of the shut-off valve to fully closed and sets the opening degree of the intake bypass valve to fully opened.

(4) In this case, if the operation state is within the regenerative operation region, the turbine rotation speed controller preferably sets the wastegate valve to fully closed.

(5) In this case, the supercharging system of the internal combustion engine further includes an intake throttle valve (e.g., later-described intake throttle valve 25) provided downstream of the section (section from later-described connecting portion a to connecting portion b) in the intake passage that is bypassed by the intake bypass passage, wherein the torque controller preferably controls the generated torque to the requested torque by performing cooperative control of the opening degree of the intake bypass valve, the valve-closing timing of the intake valve and an opening degree of the intake throttle valve.

(6) In this case, the turbine rotation speed controller preferably sets the target range by using a velocity ratio U/C0 between a peripheral velocity U of a blade of the turbine and a theoretical adiabatic spray velocity C0 of an inlet and an outlet of the turbine, the theoretical adiabatic spray velocity C0 being derived using the following equation (1) using a turbine inlet enthalpy H1 and a turbine outlet enthalpy H2 when adiabatically expanded.

C0=\sqrt{2(H1−H2)} (1)

### Effects of the Disclosure

(1) In the disclosure, if the operation state of the internal combustion engine is within the regenerative operation region, by adjusting the amount of power generated by the generator while controlling the opening degree of the wastegate valve toward the closing side and increasing an amount of exhaust energy supplied to the turbine, the turbine rotation speed is controlled within the predetermined target range set to optimize turbine efficiency. When the turbine rotation speed is controlled in this way with the aim of optimizing turbine efficiency, workload of the compressor may be greater than an amount corresponding to the requested torque. As a result, there is a risk that more air than an amount required for appropriately realizing the requested torque may flow into a combustion chamber of the internal combustion engine. Of course, such inflow of surplus air can be prevented by, for example, delaying the valve-closing timing of the intake valve. However, since the workload of the compressor cannot be reduced only by adjusting the valve-closing timing of the intake valve, there is a risk that a new problem may occur that an outlet pressure of the compressor rises with respect to an inlet pressure to cause surging. When surging occurs, there are risks that it may become impossible to maintain the turbine rotation speed within the target range set to optimize turbine efficiency, or that noises or vibrations may occur. Therefore, in the disclosure, if the turbine rotation speed is controlled within the target range and the operation state is within the supercharging operation region in which supercharging operation using the compressor is performed as described above, by performing cooperative control of the opening degree of the intake bypass valve and the valve-closing timing of the intake valve, the generated torque is controlled to the requested torque. When the intake bypass valve is opened, the air flows from the outlet side to the inlet side of the compressor through the intake bypass passage, and a difference between the inlet pressure and the outlet pressure of the compressor can be reduced. Thus, by adjusting the valve-closing timing of the intake valve as described above, while the requested torque is realized, occurrence of surging can also be prevented. Thus, in the disclosure, by combining and carrying out the turbine rotation speed control that optimizes turbine efficiency and performing cooperative control of the opening degree of the intake bypass valve and the valve-closing timing of the intake valve, while the generated torque of the internal combustion engine is controlled to the requested torque corresponding to the driver's request, the occurrence of surging in the supercharger is prevented, and the turbine rotation speed can be maintained within the target range set to optimize turbine efficiency. Thus, efficiency of the entire system made by combining the internal combustion engine, the supercharger and the generator can be improved.

(2) In the disclosure, if the turbine rotation speed is controlled within the target range by the turbine rotation speed controller because the operation state is within the regenerative operation region and the operation state is outside the supercharging operation region, while not only the outlet pressure of the compressor but also the supercharging pressure is suppressed as much as possible from rising by setting the opening degree of the intake bypass valve to fully opened, the generated torque is controlled to the requested torque by adjusting the valve-closing timing of the intake valve. Accordingly, even outside the supercharging operation region in which supercharging performed by the compressor is unnecessary, while the turbine rotation speed is controlled within the target range in which turbine efficiency is optimized, and efficient power generation is performed using the generator, the requested torque can be appropriately realized.

(3) In the disclosure, if the turbine rotation speed is controlled within the target range by the turbine rotation speed controller and the operation state is outside the supercharging operation region, the opening degree of the shut-off valve is set to fully closed and the opening degree of the intake bypass valve is set to fully opened. When the opening degree of the shut-off valve is set to fully closed and the opening degree of the intake bypass valve is set to fully opened while the turbine is rotated, the intake air flows through the intake bypass passage and the compressor idles. Accordingly, according to the disclosure, even outside the supercharging operation region in which supercharging performed by the compressor is unnecessary, while efficient power generation is performed using the generator, the requested torque can be appropriately realized.

(4) In the disclosure, if the operation state is within the regenerative operation region, the wastegate valve is set to fully closed. Accordingly, since the amount of exhaust energy supplied to the turbine can be increased to the maximum, electrical energy that can be collected by the generator can also be accordingly increased.

(5) According to the disclosure, the generated torque is controlled to the requested torque by performing cooperative control of the opening degree of the intake bypass valve, the valve-closing timing of the intake valve, and the opening degree of the intake throttle valve. Accordingly, in addition to the fact that the requested torque can be appropriately realized while the occurrence of surging is prevented as described above, pumping loss can also be suppressed. Thus, efficiency of the entire system made by combining the internal combustion engine, the supercharger and the generator can be further improved.

(6) The turbine efficiency has an upward convex characteristic relative to the velocity ratio between the peripheral velocity of the blade of the turbine and the theoretical adiabatic spray velocity of the inlet and the outlet of the turbine. In the disclosure, by using the velocity ratio correlated with the turbine efficiency in this way, the target range of the turbine rotation speed can be set within an appropriate range in which turbine efficiency is increased.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a configuration of a supercharging system according to a first embodiment of the disclosure.

FIG. 2 is a flowchart showing a specific procedure for turbine rotation speed control by means of an electronic control unit (ECU).

FIG. 3 illustrates a correlation between turbine efficiency and velocity ratio.

FIG. 4 is a flowchart showing a specific procedure for torque control by means of the ECU.

FIG. 5 illustrates an example of relationships between operation states of an engine and target operation amounts of various devices relating to torque control and turbine rotation speed control.

FIG. 6 illustrates a configuration of a supercharging system according to a second embodiment of the disclosure.

FIG. 7 is a flowchart showing a specific procedure for torque control by means of an ECU.

FIG. 8 illustrates an example of relationships between operation states of an engine and target operation amounts of various devices relating to torque control and turbine rotation speed control.

### DESCRIPTION OF THE EMBODIMENTS

### First Embodiment

Hereinafter, the first embodiment of the disclosure is explained with reference to the drawings.

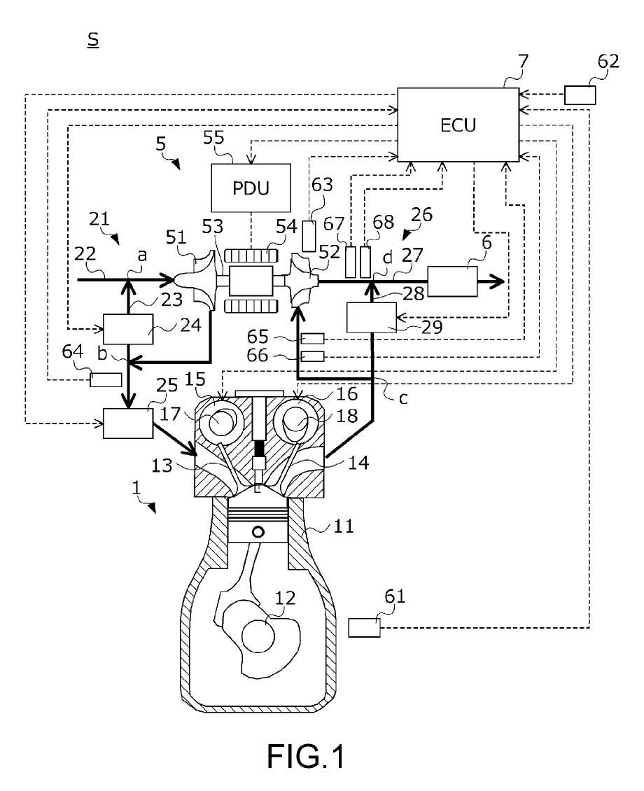

FIG. 1 illustrates a configuration of a supercharging system S of an internal combustion engine according to the present embodiment. The supercharging system S includes: an internal combustion engine (hereinafter simply referred to as “engine”) 1 being a power source; a supercharger 5 using energy of exhaust gas from the engine 1 to supercharge intake air of the engine 1 or generate electricity; an exhaust gas purification catalyst 6 purifying the exhaust gas from the engine 1; and an electronic control unit (hereinafter simply referred to as “ECU”) 7 controlling the above elements, and is mounted on an automobile (not illustrated).

The engine 1 is, for example, a multi-cylinder gasoline engine including a plurality of (i.e., two or more) cylinders 11 and using gasoline as fuel. In FIG. 1, only one of the cylinders 11 is illustrated. In the engine 1, an intake camshaft 17 and an exhaust camshaft 18 connected to a crankshaft 12 through a timing belt and rotating in conjunction with the crankshaft 12 are provided. More specifically, when the crankshaft 12 rotates twice, the intake camshaft 17 and the exhaust camshaft 18 may rotate once. On the intake camshaft 17, an intake cam is provided driving an intake valve 13 provided for each of the cylinders 11 to open and close; on the exhaust camshaft 18, an exhaust cam is provided driving an exhaust valve 14 provided for each of the cylinders 11 to open and close. Accordingly, when the intake camshaft 17 and the exhaust camshaft 18 rotate, the intake valve 13 and the exhaust valve 14 move forward and backward (open and close) in a manner corresponding to a profile of the cams provided on the camshafts.

An intake-side variable cam phase mechanism (hereinafter “IN-side VTC”) 15 changing a cam phase of the intake cam with respect to the crankshaft 12 is provided on one end portion of the intake camshaft 17. In addition, an exhaust-side variable cam phase mechanism (hereinafter “EX-side VTC”) 16 changing a cam phase of the exhaust cam with respect to the crankshaft 12 is provided on one end portion of the exhaust camshaft 18.

The IN-side VTC 15 steplessly advances or retards the cam phase of the intake camshaft 17 according to a control signal from the ECU 7, thereby variably setting a valve-opening timing or a valve-closing timing of the intake valve 13. The EX-side VTC 16 steplessly advances or retards the cam phase of the exhaust camshaft 18 according to a control signal from the ECU 7, thereby variably setting a valve-opening timing or a valve-closing timing of the exhaust valve 14.

The supercharger 5 includes: a compressor 51 rotatably provided in an intake pipe 21 through which the intake air of the engine 1 flows; a turbine 52 rotatably provided in an exhaust pipe 26 through which the exhaust gas from the engine 1 flows; a rotary shaft 53 connecting the compressor 51 and the turbine 52; a motor generator 54 functioning both as an electric motor that drives and rotates the rotary shaft 53 as a rotor using electrical energy, and as a generator that converts a shaft output of the rotary shaft 53 to electrical energy; and a power drive unit (hereinafter simply referred to as “PDU”) 55 performing power transmission and reception between the motor generator 54 and an on-automobile battery (not illustrated).

When the exhaust gas discharged from the engine 1 acts, the turbine 52 rotates using exhaust energy, i.e., thermal energy or kinetic energy of the exhaust gas. The compressor 51 is connected to the turbine 52 through the rotary shaft 53. In cases where the turbine 52 rotates due to action of the exhaust gas on the turbine 52 as described above or where the rotary shaft 53 is directly driven and rotated by the motor generator 54, the compressor 51 rotates to pressurize the intake air flowing inside the intake pipe 21.

The PDU 55 is composed of an inverter or a DC-DC converter (Direct Current-Direct Current converter) and so on, controlling the power transmission and reception between the motor generator 54 and the battery (not illustrated) according to a command signal from the ECU 7. In cases where the motor generator 54 performs power operation, the PDU 55 extracts power stored in the battery from the battery to supply it to the motor generator 54, which forcibly causes the rotary shaft 53 as well as the compressor 51 and the turbine 52 connected to the rotary shaft 53 to rotate. In addition, in cases where the motor generator 54 performs regenerative operation, since the exhaust gas acts on the turbine 52 to rotate the rotary shaft 53, the PDU 55 supplies induced electromotive force generated by the motor generator 54 to the battery. During this regenerative operation, when the amount of power generated by the motor generator 54 is increased, the electrical energy extracted from the shaft output of the rotary shaft by the motor generator increases, and braking force acting on the rotary shaft increases. Therefore, a turbine rotation speed equivalent to a rotation speed of the compressor 51, the turbine 52 and the rotary shaft 53 decreases. In addition, when the amount of power generated by the motor generator 54 is reduced during regenerative operation, since the braking force acting on the rotary shaft reduces, the turbine rotation speed increases.

The intake pipe 21 is a pipe extending from an outside of the supercharging system S to an intake port of the engine 1, and is divided into a main intake pipe 22 in which the compressor 51 of the supercharger 5 is provided, and an intake bypass pipe 23 connected to the main intake pipe 22 by a connecting portion a on an inlet side of the compressor 51 and a connecting portion b on an outlet side of the compressor 51 to bypass the compressor 51.

An intake bypass valve 24 opening and closing the intake bypass pipe 23 is provided in the intake bypass pipe 23. During rotation of the compressor 51, when the intake bypass valve 24 is opened, a part of the intake air compressed by the compressor 51 is recirculated from the outlet side to the inlet side of the compressor 51 through the intake bypass pipe 23. Accordingly, not only an outlet pressure of the compressor 51 is reduced, but also a supercharging pressure is reduced. In addition, an intake throttle valve 25 opening and closing the main intake pipe 22 is provided downstream of a section (the section from the connecting portion a to the connecting portion b in FIG. 1) in the main intake pipe 22 that is bypassed by the intake bypass pipe 23.

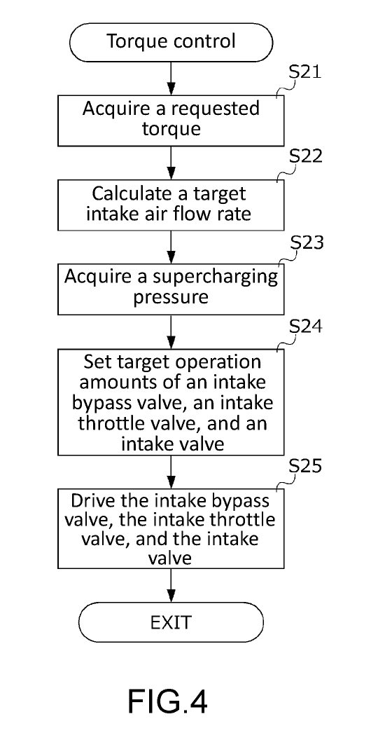

The intake bypass valve 24 and the intake throttle valve 25 are respectively connected to the ECU 7 through a driving circuit (not illustrated). The intake bypass valve 24 and the intake throttle valve 25 are controlled by torque control (see later-described FIG. 4) carried out in the ECU 7 to have an appropriate opening degree.

The exhaust pipe 26 is a pipe extending from an exhaust port of the engine 1 to the outside of the supercharging system S, and is divided into a main exhaust pipe 27 in which the turbine 52 of the supercharger 5 is provided, and an exhaust bypass pipe 28 connected to the main exhaust pipe 27 by a connecting portion c on an inlet side of the turbine 52 and a connecting portion d on an outlet side of the turbine 52 to bypass the turbine 52.

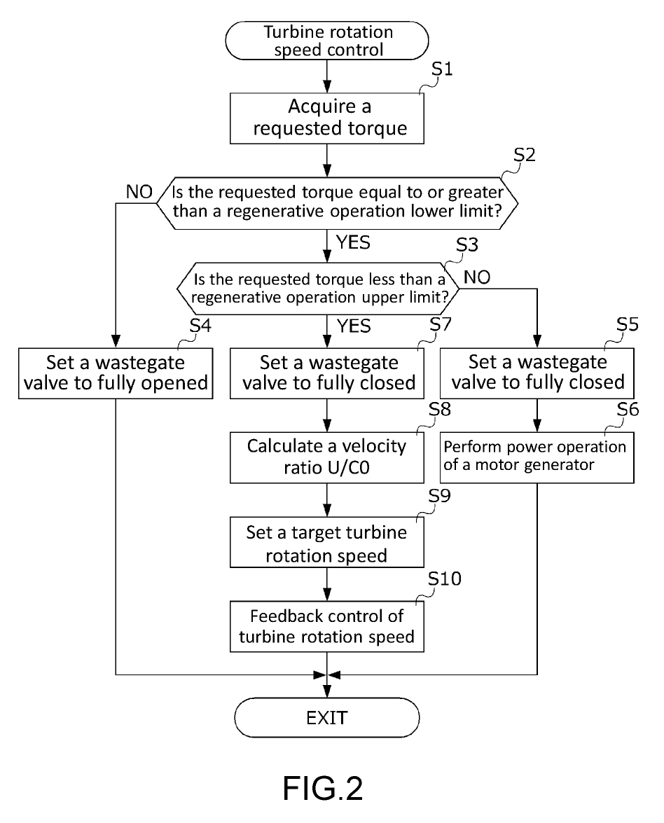

A wastegate valve 29 that opens and closes the exhaust bypass pipe 28 is provided in the exhaust bypass pipe 28. When the wastegate valve 29 is closed, the exhaust gas acts on the turbine 52, and the turbine 52 rotates due to the exhaust energy. The wastegate valve 29 is connected to the ECU 7 through a driving circuit (not illustrated). The wastegate valve 29 is controlled by turbine rotation speed control (see later-described FIG. 2) carried out in the ECU 7 to have an appropriate opening degree.

The ECU 7 is composed of an input/output (I/O) interface performing analog-to-digital (A/D) conversion on detection signals from various sensors, a memory device such as a random access memory (RAM) or a read-only memory (ROM) storing various data, and a central processing unit (CPU) carrying out various operation processes such as later-described torque control or turbine rotation speed control.

A plurality of sensors 61 to 68 for detecting an operation state of the engine 1 are connected to the ECU 7. A crank angle sensor 61 transmits a pulse signal to the ECU 7 at predetermined crank angles according to rotation of a pulser (not illustrated) fixed to the crankshaft 12. In the ECU 7, an actual engine speed is grasped based on the pulse signal from the crank angle sensor 61. An accelerator pedal sensor 62 detects a depression amount of an accelerator pedal operated by a driver, and transmits a corresponding detection signal to the ECU 7. A requested torque of the engine 1, equivalent to a request from the driver against a generated torque of the engine 1, is calculated by a process (not illustrated) in the ECU 7 based on the detection signal of the accelerator pedal sensor 62 or the engine speed and so on.

A turbine rotation speed sensor 63 detects a turbine rotation speed of the supercharger 5, and transmits a signal corresponding to the detected value to the ECU 7. A supercharging pressure sensor 64 detects, in the main intake pipe 22, a supercharging pressure equivalent to a pressure between a connecting portion and the intake throttle valve 25, wherein the connecting portion is located between the intake bypass pipe 23 and the main intake pipe 22 and downstream of the compressor 51, and transmits a signal corresponding to the detected value to the ECU 7.

A turbine inlet pressure sensor 65 detects, within a section (the section from the connecting portion c to the connecting portion d in FIG. 1) in the main exhaust pipe 27 that is bypassed by the exhaust bypass pipe 28, a turbine inlet pressure equivalent to a pressure in a portion upstream of the turbine 52, and transmits a signal corresponding to the detected value to the ECU 7. A turbine inlet temperature sensor 66 detects, within the section in the main exhaust pipe 27 that is bypassed by the exhaust bypass pipe 28, a turbine inlet temperature equivalent to a temperature of the exhaust gas in the portion upstream of the turbine 52, and transmits a signal corresponding to the detected value to the ECU 7.

A turbine outlet pressure sensor 67 detects, within the section in the main exhaust pipe 27 that is bypassed by the exhaust bypass pipe 28, a turbine outlet pressure equivalent to a pressure in a portion downstream of the turbine 52, and transmits a signal corresponding to the detected value to the ECU 7. A turbine outlet temperature sensor 68 detects, within the section in the main exhaust pipe 27 that is bypassed by the exhaust bypass pipe 28, a turbine outlet temperature equivalent to a temperature of the exhaust gas in the portion downstream of the turbine 52, and transmits a signal corresponding to the detected value to the ECU 7.

Next, a turbine rotation speed control procedure for controlling a turbine rotation speed of a supercharger by using a wastegate valve or a motor generator and so on is explained.

FIG. 2 is a flowchart showing a specific procedure for turbine rotation speed control by means of an ECU. The turbine rotation speed control in FIG. 2 is repeatedly carried out in the ECU in a predetermined cycle during start of an engine.

First of all, in S1, the ECU acquires a requested torque being an example of a parameter specifying an operation state of the engine, and then moves to S2. As described above, the requested torque is calculated by using a detection signal of an accelerator pedal sensor or an engine speed and so on.

In S2 and S3, by using the requested torque acquired in S1, the ECU determines whether or not the operation state of the engine is within a regenerative operation region being an operation region suitable for performing regenerative operation of a motor generator. More specifically, in S2, the ECU determines whether or not a value of the requested torque acquired in S1 is equal to or greater than a predetermined regenerative operation lower limit. If the value of the requested torque is less than the regenerative operation lower limit, since energy of exhaust gas discharged from the engine is considered small, the value of the requested torque is determined to be not suitable for performing regenerative operation. In addition, in S3, the ECU determines whether or not the value of the requested torque acquired in S1 is less than a predetermined regenerative operation upper limit. If the value of the requested torque is equal to or greater than the regenerative operation upper limit, since it is considered necessary to perform power operation of the motor generator in order to increase a supercharging pressure as much as possible, the value of the requested torque is determined to be not suitable for performing regenerative operation.

If the determination in S2 is NO, the ECU sets a wastegate valve to fully opened (see S4), and ends this process. When the wastegate valve is set to fully opened, since almost all of the exhaust gas discharged from the engine flows through an exhaust bypass pipe and does not act on a turbine, the turbine rotation speed becomes approximately 0. In addition, if the determination in S3 is NO, the ECU sets the wastegate valve to fully closed (see S5), and then moves to S6. When the wastegate valve is set to fully closed, almost all of the exhaust gas discharged from the engine acts on the turbine, and the turbine and a compressor rotate due to the exhaust energy. In S6, the ECU extracts power stored in a battery from the battery to perform power operation of the motor generator, and ends this process.

If the determinations of S2 and S3 are both YES, i.e., if the value of the requested torque is between the regenerative operation lower limit and the regenerative operation upper limit, the ECU determines that the operation state of the engine is within the regenerative operation region, and moves to S7 in order to carry out regenerative operation of the motor generator. In S7, the ECU controls the wastegate valve to a closing side, and more specifically, the wastegate valve is set to fully closed, so as to cause the exhaust gas discharged from the engine to act on the turbine, and then moves to S8.

In S8, the ECU calculates a value of a velocity ratio U/C0 of the turbine, and then moves to S9. Herein, the velocity ratio U/C0 of the turbine refers to a parameter correlated with turbine efficiency (equivalent to a ratio of workload of the turbine to the exhaust energy supplied to the turbine), and a value thereof is calculated by dividing a value of an outermost peripheral velocity U of the turbine by a value of a theoretical adiabatic spray velocity C0. Herein, the outermost peripheral velocity U is equivalent to a velocity on a tip end of a plurality of blades provided on the turbine, and a value thereof is calculated by multiplying a turbine rotation speed acquired using a turbine rotation speed sensor by an outer diameter of the blade of the turbine. In addition, the value of the theoretical adiabatic spray velocity C0 is, as shown in the following equation (2), calculated by using the value of turbine inlet enthalpy H1 and the value of turbine outlet enthalpy H2 when adiabatically expanded. Herein, the value of the turbine inlet enthalpy H1 is, for example, calculated by using a turbine inlet pressure obtained from an output of the turbine inlet pressure sensor 65 or a turbine inlet temperature obtained from an output of the turbine inlet temperature sensor 66 and so on. In addition, the value of the turbine outlet enthalpy H2 is, for example, calculated by using a turbine outlet pressure obtained from an output of the turbine outlet pressure sensor 67 or a turbine outlet temperature obtained from an output of the turbine outlet temperature sensor 68 and so on.

C0=\sqrt{2(H1−H2)} (2)

In S9, the ECU sets a value of a target turbine rotation speed equivalent to the target of the turbine rotation speed by using the value of the velocity ratio U/C0 calculated in S8, and then moves to S10.

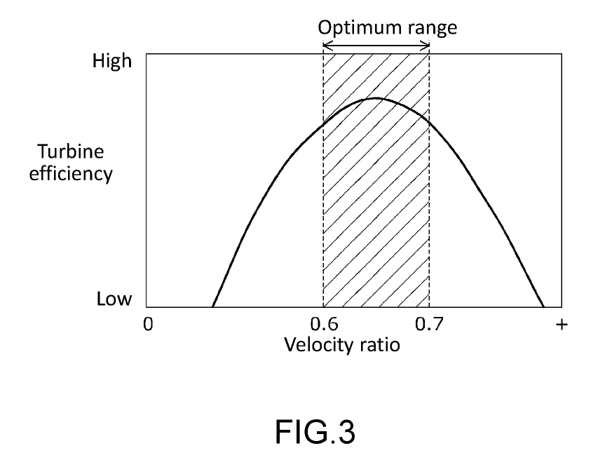

FIG. 3 illustrates a correlation between turbine efficiency and the velocity ratio U/C0. As shown in FIG. 3, the turbine efficiency has an upward convex characteristic relative to the velocity ratio U/C0. That is, the turbine efficiency has a characteristic of becoming the maximum in cases where the value of the velocity ratio U/C0 is within a predetermined optimum range (more specifically, about 0.6 to 0.7). In addition, the velocity ratio U/C0 has a proportional relationship with the turbine rotation speed. In S9, based on such relationship between turbine efficiency and velocity ratio, the ECU sets the value of the target turbine rotation speed so that the velocity ratio U/C0 falls within the optimum range for optimizing turbine efficiency.

Referring back to FIG. 2, in S10, by means of feedback control using a deviation between the target turbine rotation speed set in S9 and the turbine rotation speed detected by the turbine rotation speed sensor, the ECU adjusts an amount of power generated by the motor generator, i.e., braking force acting on a rotary shaft from the motor generator, so that the turbine rotation speed becomes the target turbine rotation speed.

Next, a torque control procedure for controlling a generated torque of the engine by performing cooperative control and using an intake bypass valve, an IN-side VTC, and an intake valve is explained.

FIG. 4 is a flowchart showing a specific procedure for torque control by means of the ECU. The torque control in FIG. 4 is repeatedly carried out in the ECU in a predetermined cycle in parallel with the turbine rotation speed control in FIG. 2 during start of the engine.

First of all, in S21, the ECU acquires a requested torque similarly as in S1 in FIG. 2, and then moves to S22. In S22, the ECU calculates a value of an intake air flow rate required in the engine for appropriately realizing the requested torque acquired in S21, uses this value as a target intake air flow rate, and then moves to S23. In S23, the ECU acquires a supercharging pressure using an output signal of a supercharging pressure sensor, and then moves to S24.

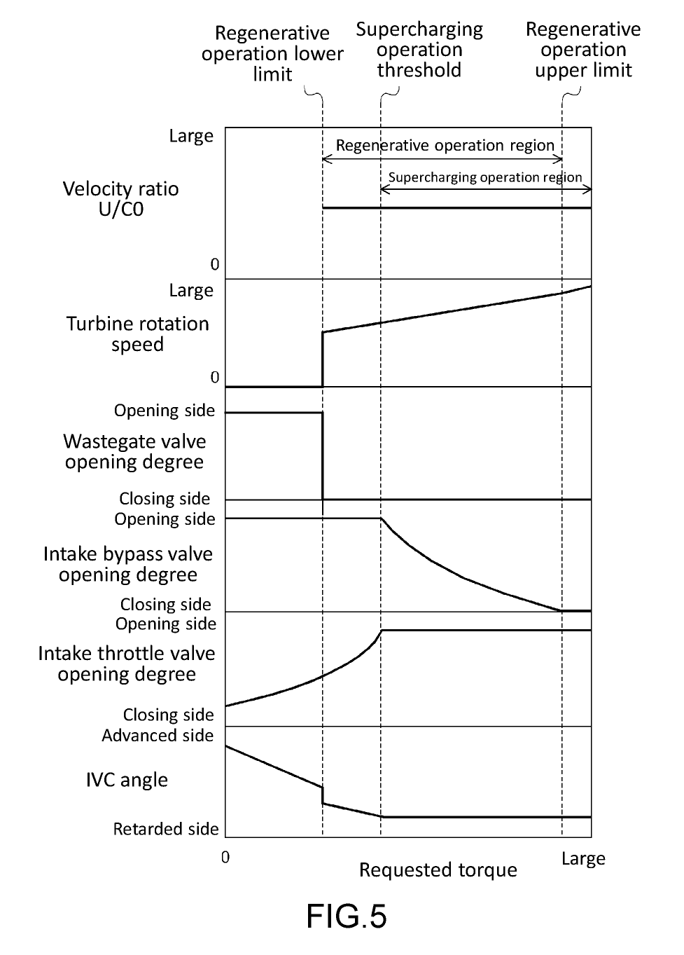

In S24 and S25, by performing cooperative control of an opening degree of an intake bypass valve, an opening degree of an intake throttle valve and a valve-closing timing of an intake valve in an intake stroke, the ECU appropriately realizes the target intake air flow rate set according to the requested torque. More specifically, in S24, by using the requested torque, the target intake air flow rate and the supercharging pressure acquired in the previous steps, target operation amounts of various devices relating to torque control, such as a target opening degree of the intake bypass valve, the valve-closing timing of the intake valve, and a target opening degree of the intake throttle valve for realizing the target intake air flow rate, i.e., for controlling the generated torque of the engine to the requested torque, are calculated, and then the process moves to S25. In the following, the operation state of the engine is divided into four qualitatively different states, and a specific procedure for setting the target operation amounts of various devices for each operation state is explained with reference to FIG. 5.

FIG. 5 illustrates an example of relationships between operation states of the engine and operation amounts of various devices relating to turbine rotation speed control and torque control. In FIG. 5, the upper three sections show the relationships between requested torque and, respectively, velocity ratio U/C0, turbine rotation speed and opening degree of the wastegate valve, in turbine rotation speed control. In FIG. 5, the lower three sections show the relationships between requested torque and, respectively, opening degree of the intake bypass valve, opening degree of the intake throttle valve, and IVC angle (intake-valve-closing angle) equivalent to the valve-closing timing of the intake valve in the intake stroke, in torque control.

The operation state of the engine is divided into the following four cases: 1. a case where the operation state is outside the regenerative operation region, and outside a supercharging operation region in which a supercharging operation performed by the compressor of the supercharger becomes necessary; 2. a case where the operation state is within the regenerative operation region and outside the supercharging operation region; 3. a case where the operation state is within the regenerative operation region and within the supercharging operation region; and 4. a case where the operation state is outside the regenerative operation region and within the supercharging operation region. Moreover, in cases where the requested torque is used as a parameter specifying an operation state of the engine, as shown in FIG. 5, the supercharging operation region is defined as a region in which the value of the requested torque is equal to or greater than a supercharging operation threshold set between the regenerative operation lower limit and the regenerative operation upper limit that define the regenerative operation region.

First of all, the case where the operation state of the engine is outside the regenerative operation region and outside the supercharging operation region is explained. In this case, the target opening degree of the intake bypass valve is set to the maximum opening degree (i.e., fully opened) regardless of the value of the requested torque. In addition, in this region, while the intake bypass valve is maintained fully opened, the IVC angle and the opening degree of the intake throttle valve are adjusted so as to realize the target intake air flow rate. In this case, it is preferred that, as the requested torque increases, the target opening degree of the intake throttle valve increases, and the IVC angle is changed to a retarded side. Accordingly, while the target intake air flow rate is realized, unnecessary pumping loss can be suppressed.

Next, the case where the operation state of the engine is within the regenerative operation region and outside the supercharging operation region is explained. Since this region is within the regenerative operation region, the wastegate valve is closed and the turbine rotation speed control that controls the turbine rotation speed to the target turbine rotation speed is carried out. Therefore, work performed by the compressor considerably occurs. In addition, since this region is outside the supercharging operation region in which supercharging performed by the compressor is unnecessary, it is necessary to suppress a rise in the supercharging pressure as much as possible. Therefore, in this region, by setting the target opening degree of the intake bypass valve to the maximum opening degree regardless of the value of the requested torque, and by recirculating the air on an outlet side of the compressor to an inlet side thereof as much as it can be, not only an outlet pressure of the compressor but also the supercharging pressure is suppressed from rising. In addition, in this region, by adjusting the target opening degree of the intake throttle valve and the IVC angle according to the value of the requested torque while maintaining the intake bypass valve fully opened, the target intake air flow rate is realized. More specifically, it is preferred that, as the requested torque increases, the target opening degree of the intake throttle valve increases, and the IVC angle is changed to the retarded side. Accordingly, while the target intake air flow rate is realized, unnecessary pumping loss can be suppressed.

By the way, according to the turbine rotation speed control in FIG. 2, when the operation state of the engine changes from outside the regenerative operation region to within the regenerative operation region, the wastegate valve is switched from fully opened to fully closed, and the compressor starts to rotate. On this occasion, although a considerable rise in the supercharging pressure is prevented by maintaining the intake bypass valve fully opened as described above, since the compressor has started to rotate, there is a risk that the supercharging pressure may slightly rise more than the pressure required for appropriately realizing the requested torque, and surplus air exceeding the target intake air flow rate may flow in. Therefore, when the operation state changes from outside the regenerative operation region to within the regenerative operation region, as shown in FIG. 5, the IVC angle is changed to the retarded side in a stepped manner, and such inflow of surplus air is prevented. Moreover, although such inflow of surplus air can also be prevented by changing the opening degree of the intake throttle valve to a closing side in a stepped manner, to suppress unnecessary pumping loss, it is preferred to first change the IVC angle as shown in FIG. 5.

Next, the case where the operation state of the engine is within the regenerative operation region and within the supercharging operation region is explained. In this region, in the first place, the target opening degree of the intake throttle valve is set to the maximum opening degree (i.e., fully opened) regardless of the value of the requested torque, so as to suppress pumping loss as much as possible. In addition, in this region, since the turbine rotation speed is controlled so as to optimize turbine efficiency, workload of the compressor may be increased more than an amount corresponding to the requested torque. As a result, there is a risk that surplus air exceeding the target intake air flow rate required for appropriately realizing the requested torque may flow into a combustion chamber of the engine. In order to prevent such inflow of surplus air, the IVC angle is set to the minimum angle within a permissible range regardless of the value of the requested torque. That is, by setting the valve-closing timing of the intake valve to the most retarded side within the permissible range, inflow of surplus air is prevented as much as possible. In addition, since the workload of the compressor cannot be reduced in the retardation of the IVC angle, there is a risk that the outlet pressure of the compressor may rise with respect to the inlet pressure to cause surging. When surging occurs, there are risks that it may become impossible to maintain the turbine rotation speed at the target turbine rotation speed, or that noises or vibrations may occur. Therefore, in this region, by setting the target opening degree of the intake throttle valve and the IVC angle as described above, and further, by adjusting the target opening degree of the intake bypass valve between the maximum opening degree and the minimum opening degree (i.e., fully closed) thereof according to the value of the requested torque, the target intake air flow rate is realized. More specifically, as shown in FIG. 5, it is preferred to set the target opening degree of the intake bypass valve to reduce as the requested torque increases, i.e., as the supercharging pressure required for realizing the requested torque increases. By controlling the opening degree of the intake bypass valve in this way, while occurrence of surging is prevented, the target intake air flow rate can be appropriately realized.

Next, the case where the operation state of the engine is outside the regenerative operation region and within the supercharging operation region is explained. In this region, the target opening degree of the intake bypass valve is set to the minimum opening degree regardless of the value of the requested torque, and the target opening degree of the intake throttle valve is set to the maximum opening degree regardless of the value of the requested torque. In addition, in this region, the IVC angle is set to the minimum angle regardless of the value of the requested torque. That is, the valve-closing timing of the intake valve in the intake stroke is set to the most retarded side within the permissible range regardless of the value of the requested torque.

In S25, the ECU drives the intake bypass valve, the IN-side VTC, and the intake throttle valve, so as to realize the targets respectively performed a cooperative control and set as described above in S24 according to the operation state of the engine, and ends this process.

According to the supercharging system of the present embodiment, the following effects are achieved.

(1) In the present embodiment, if the operation state of the engine is within the regenerative operation region, by adjusting the amount of power generated by the motor generator while controlling the opening degree of the wastegate valve toward the closing side and increasing an amount of exhaust energy supplied to the turbine, the turbine rotation speed is controlled toward the target turbine rotation speed set to optimize turbine efficiency. In addition, in the present embodiment, if the turbine rotation speed is controlled toward the target turbine rotation speed and the operation state is within the supercharging operation region, by performing cooperative control of the opening degree of the intake bypass valve and the valve-closing timing of the intake valve, the generated torque is controlled to the requested torque. That is, in the present embodiment, by combining and carrying out the turbine rotation speed control that optimizes turbine efficiency and the cooperative control of the opening degree of the intake bypass valve and the valve-closing timing of the intake valve, while the generated torque of the internal combustion engine is controlled to the requested torque, the occurrence of surging in the supercharger is prevented, and the turbine rotation speed can be maintained at the target turbine rotation speed set to optimize turbine efficiency. Thus, efficiency of the entire supercharging system made by combining the engine, the supercharger and the motor generator can be improved.

(2) In the present embodiment, if the operation state of the engine is within the regenerative operation region and outside the supercharging operation region, while not only the outlet pressure of the compressor but also the supercharging pressure is suppressed as much as possible from rising by setting the opening degree of the intake bypass valve to fully opened, the generated torque is controlled to the requested torque by adjusting the IVC angle of the intake valve. Accordingly, even outside the supercharging operation region in which supercharging performed by the compressor is unnecessary, while the turbine rotation speed is controlled to the target turbine rotation speed, and efficient power generation is performed using the motor generator, the requested torque can be appropriately realized.

(3) In the present embodiment, if the operation state of the engine is within the regenerative operation region, the wastegate valve is set to fully closed. Accordingly, since the amount of exhaust energy supplied to the turbine can be increased to the maximum, electrical energy that can be collected by the generator can also be accordingly increased.

(4) According to the disclosure, the generated torque is controlled to the requested torque by performing cooperative control of the opening degree of the intake bypass valve, the valve-closing timing of the intake valve, and the opening degree of the intake throttle valve. Accordingly, in addition to the fact that the requested torque can be appropriately realized while the occurrence of surging is prevented as described above, pumping loss can also be suppressed. Thus, efficiency of the entire system made by combining the internal combustion engine, the supercharger and the generator can be further improved.

(5) The turbine efficiency has an upward convex characteristic relative to the velocity ratio between the peripheral velocity of the blade of the turbine and the theoretical adiabatic spray velocity of the inlet and the outlet of the turbine. In the disclosure, by using such correlated velocity ratio, the target turbine rotation speed can be set within an appropriate range in which turbine efficiency is increased.

### Second Embodiment

Next, a supercharging system Sa according to the second embodiment of the disclosure is explained with reference to the drawings. Moreover, in the following explanation, the same configurations as in the first embodiment are denoted by the same reference numerals and detailed explanations thereof are omitted.

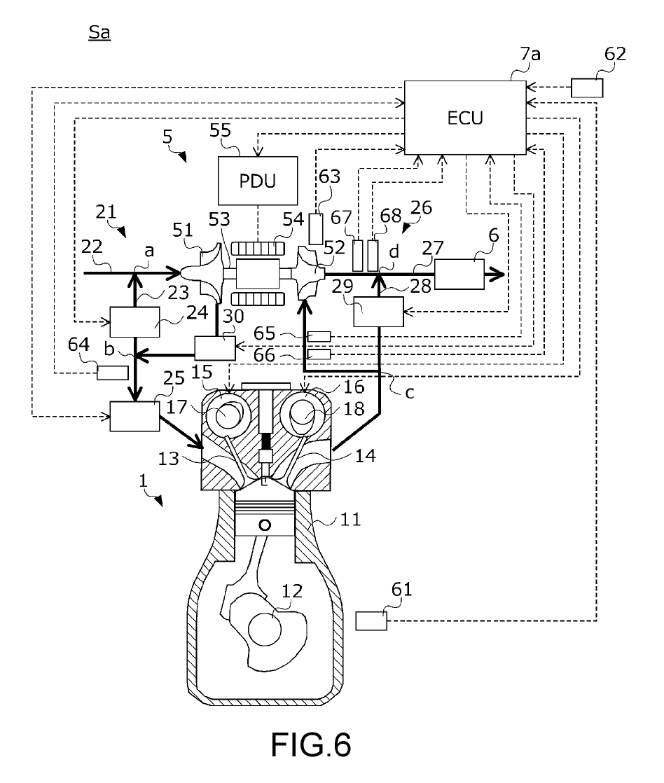

FIG. 6 illustrates a configuration of the supercharging system Sa according to the present embodiment. The supercharging system Sa according to the present embodiment differs from the supercharging system S according to the first embodiment in that a shut-off valve 30 opening and closing the main intake pipe 22 is provided within a section (the section from the connecting portion a to the connecting portion b in FIG. 6) in the main intake pipe 22 that is bypassed by the intake bypass pipe 23. More specifically, the shut-off valve 30 is provided within the section bypassed by the intake bypass pipe 23 and downstream of the compressor 51 of the supercharger 5.

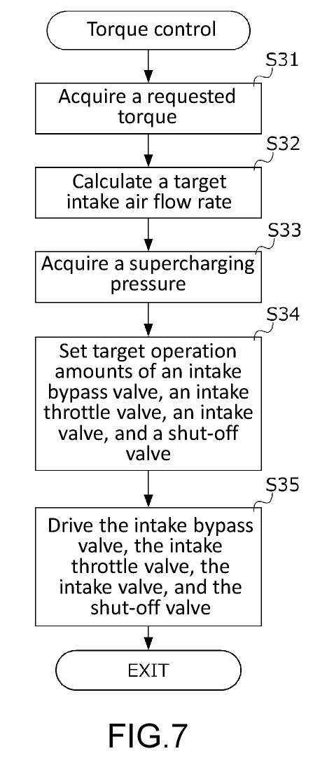

During rotation of the compressor 51, when the shut-off valve 30 is closed and the intake bypass valve is opened, the intake air flows through the intake bypass pipe 23, and the compressor 51 idles. Thus, a rise in the supercharging pressure is suppressed. The shut-off valve 30 is connected to an ECU 7a through a driving circuit (not illustrated). The shut-off valve 30 is controlled by torque control (see later-described FIG. 7) carried out in the ECU 7a to have an appropriate opening degree.

FIG. 7 is a flowchart showing a specific procedure for torque control by means of an ECU. The torque control in FIG. 7 is repeatedly carried out in the ECU in a predetermined cycle in parallel with the turbine rotation speed control in FIG. 2 during start of the engine. In addition, in the process shown in FIG. 7, S31 to S33 are respectively the same as S21 to S23 in FIG. 4, and explanations thereof are thus omitted.

In S34 and S35, by performing cooperative control of the opening degree of the intake bypass valve, the opening degree of the intake throttle valve, the valve-closing timing of the intake valve in the intake stroke, and an opening degree of a shut-off valve, the ECU realizes the target intake air flow rate set according to the requested torque. More specifically, in S34, by using the requested torque, the target intake air flow rate, and the supercharging pressure acquired in the previous steps, target operation amounts of various devices relating to torque control, such as the target opening degree of the intake bypass valve, the valve-closing timing of the intake valve, the target opening degree of the intake throttle valve, and a target opening degree of the shut-off valve for realizing the target intake air flow rate, i.e., for controlling the generated torque of the engine to the requested torque, are calculated, and then the process moves to S35.

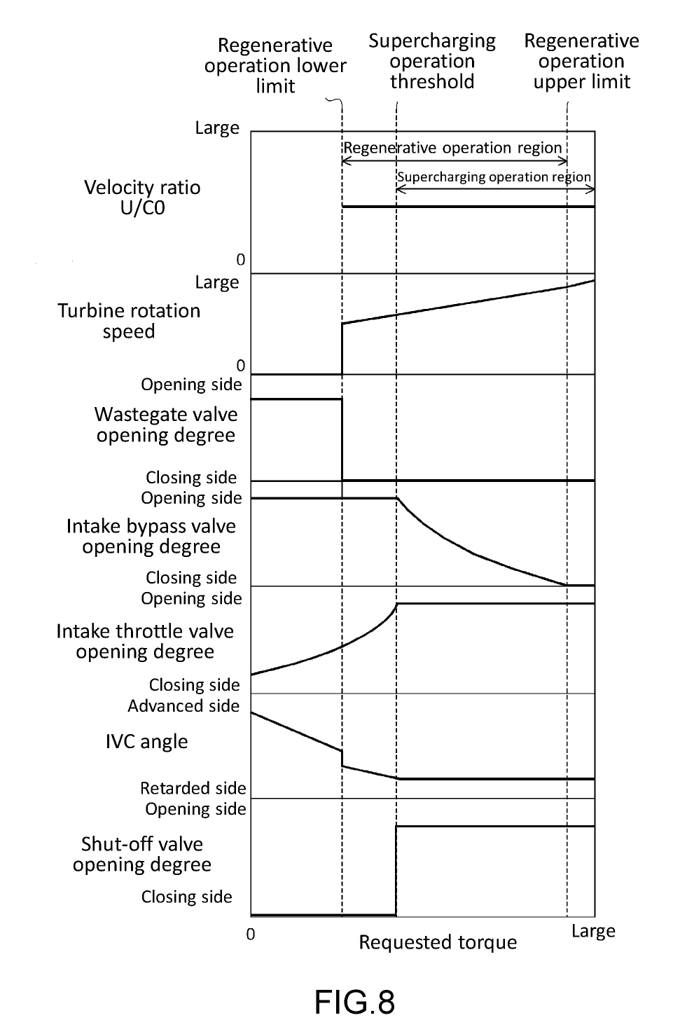

FIG. 8 illustrates an example of relationships between operation states of the engine and operation amounts of various devices relating to turbine rotation speed control and torque control. In FIG. 8, the upper three sections show the relationships between requested torque and, respectively, velocity ratio U/C0, turbine rotation speed and opening degree of the wastegate valve, in turbine rotation speed control. In FIG. 8, the lower four sections show the relationships between requested torque and, respectively, opening degree of the intake bypass valve, opening degree of the intake throttle valve, IVC angle equivalent to the valve-closing timing of the intake valve in the intake stroke, and opening degree of the shut-off valve, in torque control.

As shown in FIG. 8, the target operation amounts of the intake bypass valve, the intake throttle valve and the intake valve in each operation region are the same as in the supercharging system S of the first embodiment. Thus, explanations thereof are omitted. In addition, as shown in FIG. 8, while the operation state is outside the supercharging operation region and the intake bypass valve is set to fully opened, the target opening degree of the shut-off valve is set to the minimum opening degree (i.e., fully closed) regardless of the value of the requested torque so that the supercharging pressure does not rise even if the compressor rotates. In addition, if the operation state is within the supercharging operation region, the target opening degree of the shut-off valve is set to the maximum opening degree (i.e., fully opened) regardless of the value of the requested torque so as not to hinder a rise in the supercharging pressure.

According to the supercharging system of the present embodiment, in addition to the above (1) to (5), the following effect is achieved.

(6) In the disclosure, if the turbine rotation speed is controlled within a target range by a turbine rotation speed controller, and the operation state is outside the supercharging operation region, the opening degree of the shut-off valve is set to fully closed and the opening degree of the intake bypass valve is set to fully opened. When the opening degree of the shut-off valve is set to fully closed and the opening degree of the intake bypass valve is set to fully opened while the turbine is rotated, the intake air flows through an intake bypass passage and the compressor idles. Accordingly, according to the disclosure, even outside the supercharging operation region in which supercharging performed by the compressor is unnecessary, while efficient power generation is performed using the generator, the requested torque can be appropriately realized.

The above has explained two embodiments of the disclosure, but the disclosure is not limited thereto. Details of the construction may be properly changed within the scope of spirit of the disclosure.

What is claimed is:

1. A supercharging system of an internal combustion engine, comprising:
a supercharger, comprising a compressor provided in an intake passage of the internal combustion engine, a turbine provided in an exhaust passage of the internal combustion engine, a rotary shaft connecting the turbine and the compressor, and a generator converting a part of a shaft output of the rotary shaft to an electrical energy;
a wastegate valve, opening and closing an exhaust bypass passage connected to the exhaust passage on an inlet side and an outlet side of the turbine;
a turbine rotation speed controller, controlling a turbine rotation speed using the wastegate valve and the generator;
an intake bypass valve, opening and closing an intake bypass passage connected to the intake passage on an inlet side and an outlet side of the compressor;
a variable valve-closing timing device, variably setting a valve-closing timing of an intake valve of the internal combustion engine;
a torque controller, controlling a generated torque of the internal combustion engine using the intake bypass valve and the variable valve-closing timing device; and
a regeneration determination unit, determining whether or not an operation state of the internal combustion engine is within a regenerative operation region in which a regenerative operation of the generator is performed, wherein
if the operation state is within the regenerative operation region, the turbine rotation speed controller controls the turbine rotation speed within a target range set to optimize a turbine efficiency by controlling an opening degree of the wastegate valve toward a closing side and by adjusting an amount of power generated by the generator;
if the turbine rotation speed is controlled within the target range and the operation state is within a supercharging operation region in which supercharging operation of the compressor is performed, the torque controller controls the generated torque to a requested torque by performing cooperative control of an opening degree of the intake bypass valve and the valve-closing timing of the intake valve.

2. The supercharging system of the internal combustion engine according to claim 1, wherein if the turbine rotation speed is controlled within the target range and the operation state is outside the supercharging operation region, the torque controller controls the generated torque to the requested torque by adjusting the valve-closing timing of the intake valve while setting the opening degree of the intake bypass valve to fully opened.

3. The supercharging system of the internal combustion engine according to claim 2, further comprising:
a shut-off valve, provided within a section in the intake passage that is bypassed by the intake bypass passage;
wherein if the turbine rotation speed is controlled within the target range and the operation state is outside the supercharging operation region, the torque controller sets an opening degree of the shut-off valve to fully closed and sets the opening degree of the intake bypass valve to fully opened.

4. The supercharging system of the internal combustion engine according to claim 1, wherein if the operation state is within the regenerative operation region, the turbine rotation speed controller sets the wastegate valve to fully closed.

5. The supercharging system of the internal combustion engine according to claim 1, further comprising:
an intake throttle valve, provided downstream of the section in the intake passage that is bypassed by the intake bypass passage, wherein
the torque controller controls the generated torque to the requested torque by performing cooperative control of the opening degree of the intake bypass valve, the valve-closing timing of the intake valve and an opening degree of the intake throttle valve.

6. The supercharging system of the internal combustion engine according to claim 1, wherein the turbine rotation speed controller sets the target range by using a velocity ratio U/C0 between a peripheral velocity U of a blade of the turbine and a theoretical adiabatic spray velocity C0 of an inlet and an outlet of the turbine, the theoretical adiabatic spray velocity C0 being derived using the following equation (1) using a turbine inlet enthalpy H1 and a turbine outlet enthalpy H2 when adiabatically expanded:
C0=\sqrt{2(H1−H2)} (1).
